(19) United States
(12) Patent Application Publication
(10) Pub. No.: US 2011/0142721 A1
(43) Pub. Date: Jun. 16, 2011

(54) FUEL GASIFICATION EQUIPMENT

(75) Inventors: Takahiro Murakami, Tokyo (JP); Satoko Aoki, Tokyo (JP); Toshiyuki Suda, Tokyo (JP); Hidehisa Tani, Tokyo (JP)

(73) Assignee: IHI Corporation, Tokyo (JP)

(21) Appl. No.: 13/059,007

(22) PCT Filed: Aug. 20, 2008
(86) PCT No.: PCT/JP2008/002244

§ 371 Date: Feb. 22, 2011

(51) Int. Cl. B01J 8/18

(52) U.S. Cl. 422/139

(57) ABSTRACT

Provided is a fuel gasification equipment capable of effectively utilizing a CO₂ gas finally separated from a product or combustible gas such as H₂ and CO for supply of a solid fuel to a gasification furnace, enabling stable supply of the solid fuel to the gasification furnace. The equipment has CO₂ gas separation/circulation means for separating CO₂ gas from the gasification gas produced in the gasification furnace 2 and introducing the separated CO₂ gas to a supply system supplying the solid fuel to the gasification furnace 2.

### TECHNICAL FIELD

The present invention relates to a fuel gasification equipment.

### BACKGROUND ART

A fuel gasification equipment has been developed which uses as fuel solid fuel such as coal, biomass, waste plastic or various wet wastes to produce a gasification gas.

FIGS. 1 and 2 show an example of a conventional fuel gasification equipment comprising a gasification furnace 2 having a fluidized bed 1 of a bed material (such as silica sand or limestone) formed with steam and a fluidizing reaction gas such as air or oxygen to gasify a solid fuel (such as coal or biomass) charged for production of a gasification gas and a flammable solid content, a combustion furnace 5 fed with the flammable solid content produced in the gasification furnace 2 along with the bed material through an introduction pipe 3 and having a fluidized bed 4 formed with a fluidizing reaction gas to burn the flammable solid content, a material separator 8 such as a hot cyclone for separating the bed material from an exhaust gas introduced via an exhaust gas pipe 6 from the combustion furnace 5 to supply the separated bed material via a downcomer 7 to the gasification furnace 2, a material separator 9 such as a hot cyclone for separating the bed material from the gasification gas produced in the gasification furnace 2, and a recovery vessel 10 for recovering the bed material separated by the separator 9.

In FIGS. 1 and 2, reference numeral 11 denotes a distribution plate for uniformly blowing into the fluidized bed 1 the steam and the fluidizing reaction gas introduced to the bottom of the gasification furnace 2; 12, a partition for covering an inner portion of the gasification furnace 2 connected to the introduction pipe 3 such that only a bottom of the portion is opened to prevent the bed material in the fluidized bed 1 from directly flowing out into the introduction pipe 3; 13, a distribution plate for uniformly blowing into the fluidized bed 4 the fluidizing reaction gas introduced to the bottom of the combustion furnace 5; 14, a hopper for storing the solid fuel; 15, a screw feeder for cutting and extracting the stored solid fuel from the hopper 14; and 16, a fuel supply pipe fed with the solid fuel cut and extracted by the screw feeder 15 and connected to a side surface of the gasification furnace 2 at a position higher than a top surface of the fluidized bed 1.

In the gasification equipment as described above, the fluidized bed 1 is formed with steam and the fluidizing reaction gas such as air or oxygen in the gasification furnace 2. When the solid fuel such as coal or biomass stored in the hopper 14 is cut and extracted by the screw feeder 15 and charged into the fluidized bed 1 through the fuel supply pipe 16, the solid fuel is partially oxidized and gasified into the gasification gas and the flammable solid content. The flammable solid content produced in the gasification furnace 2 is introduced through the introduction pipe 3 along with the bed material into the combustion furnace 5 having the fluidized bed 4 formed with the fluidizing reaction gas to burn the flammable solid content. An exhaust gas from the combustion furnace 5 is introduced through the exhaust gas pipe 6 into the material separator 8 where the bed material is separated from the exhaust gas. The separated bed material is returned through the downcomer 7 to the gasification furnace 2 for circulation.

Since a high temperature is retained in the gasification furnace 2 in the presence of steam supplied to the bottom of the gasification furnace 2 and moisture evaporated from the solid fuel itself and a gas produced by pyrolysis of the solid fuel and a residual fuel are react with steam, a water gasification reaction C+H₂O═H₂+CO and a hydrogen conversion reaction CO+H₂O═H₂+CO₂ occur, producing a combustible gasification gas such as H₂ and CO.

From the gasification gas produced in the gasification furnace 2, the bed material is separated by the material separator 9 and is recovered to the recovery vessel 10.

An equipment configuration similar to the fuel gasification equipment shown in FIGS. 1 and 2 is disclosed, for example, in Patent Literature 1.
Patent Literature 1: JP 2006-207947A

### SUMMARY OF INVENTION

### Technical Problems

In the conventional fuel gasification equipment as mentioned in the above, the gasification gas produced in the gasification furnace 2 also contains CO₂. CO₂ contained in the gasification gas is not necessarily utilized effectively in the present situation even though it is finally separated from a product or combustible gas such as H₂ and CO.

The invention was made in view of the above and has its object to provide a fuel gasification equipment capable of effectively utilizing a CO₂ gas finally separated from a product or combustible gas such as H₂ and CO for supply of a solid fuel to a gasification furnace, thereby realizing stable supply of the solid fuel to the gasification furnace.

### Solution to Problems

The invention is directed to a fuel gasification equipment comprising:

a gasification furnace having a fluidized bed of a bed material formed with a fluidizing reactive gas for gasifying a solid fuel charged to produce a gasification gas and a flammable solid content; and

CO₂ gas separation/circulation means for separating CO₂ gas from the gasification gas produced in the gasification furnace and introducing the separated CO₂ gas to a supply system supplying the solid fuel to the gasification furnace.

By the above measures, the following effects are obtained.

In the fuel gasification equipment configured as above, the CO₂ gas separated from the gasification gas is effectively utilized for supply of the solid fuel to the gasification furnace, and consequently the solid fuel is stably supplied to the gasification furnace. Further, a type of gasification reaction in the gasification furnace

C+CO₂→2CO

is promoted, leading to improvement of gasification efficiency.

In the fuel gasification equipment, the CO₂ gas separation/circulation means may be provided by a CO₂ separator arranged in front of an FT synthesizer for conducting a Fischer-Tropsch synthesis reaction to adjust an H₂/CO ratio in the gasification gas to approximately 2.

In the fuel gasification equipment, the CO₂ gas separation/circulation means may be provided by a CO₂ separator arranged in front of an ammonia synthesizer for producing ammonia through mixing of H₂ in the gasification gas with N₂.

In the fuel gasification equipment, introduction of the CO₂ gas separated by the CO₂ gas separation/circulation means into a hopper storing the solid fuel is effective for dryness of the solid fuel and pressure-feeding of the solid fuel with the CO₂ gas to steadily supply the same.

In the fuel gasification equipment, a fuel supply pipe may be connected to a side surface of the gasification furnace at a position lower than a top surface of the fluidized bed to supply the solid fuel from the fuel supply pipe to an inside of the fluidized bed; and a fluidizing gas pipe may be connected to the fuel supply pipe close to a connection thereof to the gasification furnace for introduction of the CO₂ gas separated by the CO₂ gas separation/circulation means into the fluidizing gas pipe as fluidizing gas for stable supply of the solid fuel to an inside of the fluidized bed. This allows fine particles of the solid fuel to make full contact with the bed material without scattering unlike a case where the solid fuel is supplied from the fuel supply pipe to the gasification furnace at a position above the fluidized bed, so that the pyrolysis of the solid fuel is reliably completed to enhance achievable gas calorific value, i.e., cold gas efficiency as well as C- and H-conversion ratios while also enabling the reforming of tar in the gasification gas. It may be conceivable that especially when biomass is used as the solid fuel in the configuration where fuel supply pipe is connected to the side surface of the gasification furnace at a position lower than the top surface of the fluidized bed so that the solid fuel is supplied from the fuel supply pipe to the inside of the fluidized bed, the biomass, which contains more volatile components than coal and is easily gasificable, may heat up to some hundreds of degrees (° C.) to melt and gradually stick in the connection of the fuel supply pipe to the gasification furnace, leading to clogging of the fuel supply pipe. In the above-mentioned configuration, however, the CO₂ gas is supplied as fluidizing gas from the fluidizing gas pipe connected to the fuel supply pipe to promote the fluidity of the solid fuel; as a result, even when biomass is used as the solid fuel, sticking of molten biomass to the connection of the fuel supply pipe is avoided and the fear of the clogging of the fuel supply pipe is eliminated.

### Advantageous Effects of Invention

According to the fuel gasification equipment of the invention, the CO₂ finally separated from the product or combustible gas such as H₂ and CO can be effectively utilized for supply of the solid fuel to the gasification furnace, and consequently the solid fuel can be stably supplied to the gasification furnace.

### BRIEF DESCRIPTION OF DRAWINGS

FIG. 1 is an overall schematic diagram showing an example of a conventional fuel gasification equipment;

FIG. 2 is a relevant part diagram showing a gasification furnace in the example of the conventional fuel gasification equipment;

FIG. 3 is a block diagram showing a system configuration of a first embodiment of the invention;

FIG. 4 is a relevant part diagram showing a specific example of the gasification furnace in the first embodiment of the invention;

FIG. 5 is a relevant part diagram showing a modification of the gasification furnace shown in FIG. 4;

FIG. 6 is a relevant part diagram showing another specific example of the gasification furnace in the first embodiment of the invention; and

FIG. 7 is a block diagram showing a system configuration of a second embodiment of the invention.

### REFERENCE SIGNS LIST

1 fluidized bed
2 gasification furnace
3 introduction pipe
5 combustion furnace
7 downcomer
8 material separator
10 recovery vessel
11 dispersion plate
14 hopper (supply system)
15 screw feeder
16 fuel supply pipe (supply system)
22 CO₂ separator (CO₂ gas separation/circulation means)
23 FT synthesizer
24 fluidizing gas pipe
25 ammonia synthesizer

### DESCRIPTION OF EMBODIMENTS

Embodiments of the invention will be described in conjunction with the drawings.

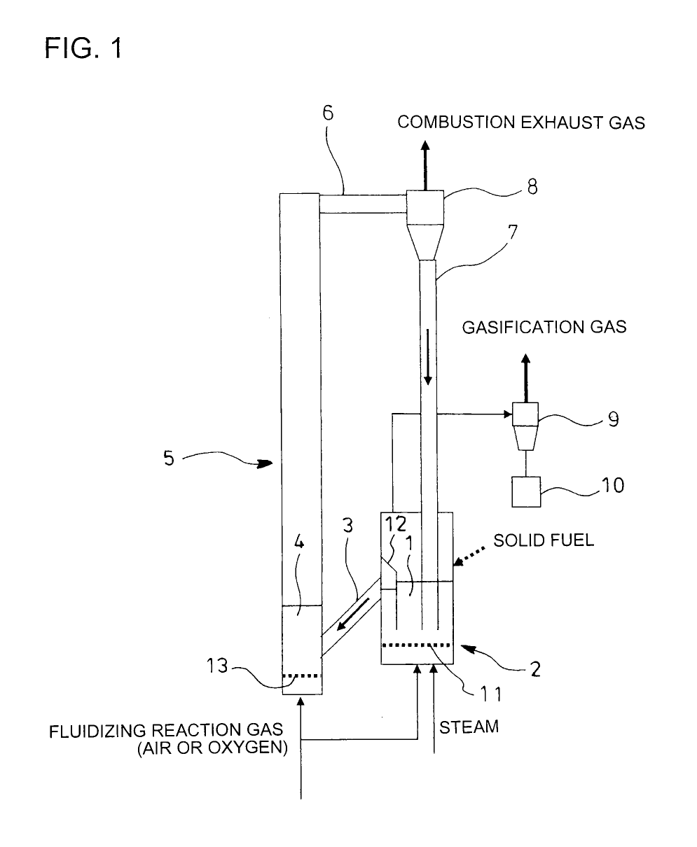

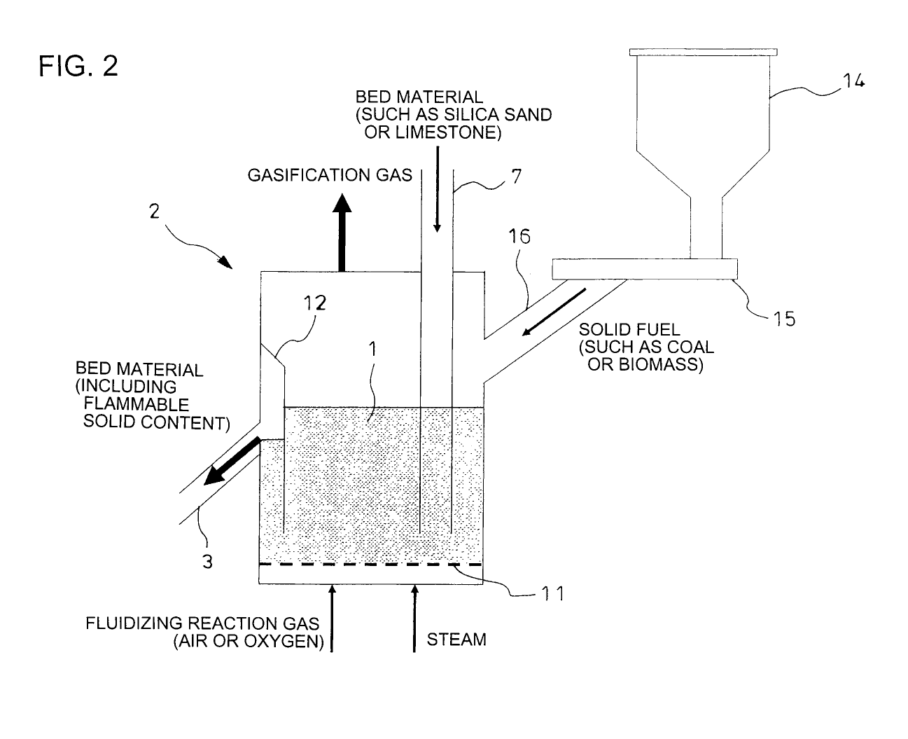

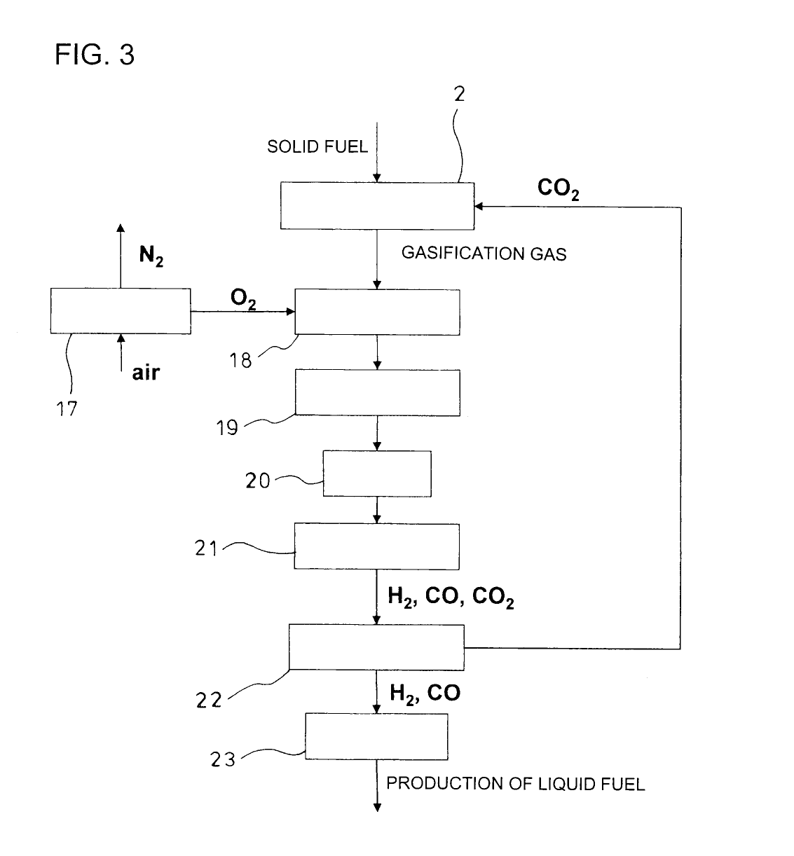

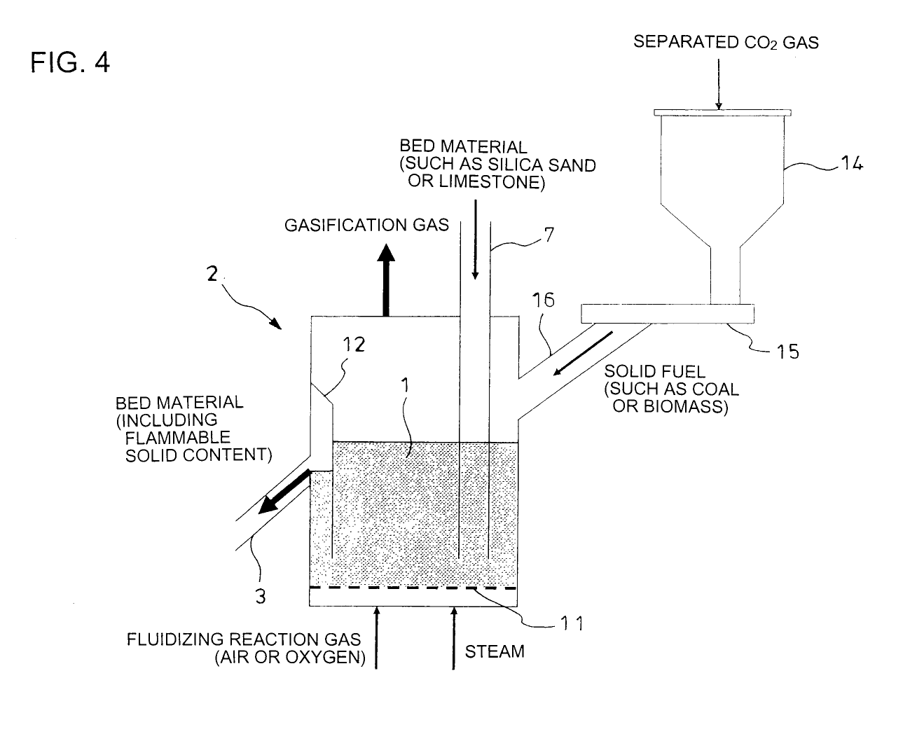

FIGS. 3 and 4 show a first embodiment of the invention in which portions similar to those in FIGS. 1 and 2 are represented by the same reference numerals. This embodiment, which is similar in basic configuration to the conventional one shown in FIGS. 1 and 2, is characteristic as shown in FIGS. 3 and 4 in provision of CO₂ gas separation/circulation means which separates CO₂ gas from a gasification gas produced in a gasification furnace 2 and introduces the separated CO₂ gas to a supply system for supplying the solid fuel to the gasification furnace 2.

The embodiment includes:

an O₂ separator 17 which separates air into O₂ and N₂;

a high-temperature reforming furnace 18 which mixes the gasification gas produced by the gasification furnace 2 and made free from the bed material by the material separator 9 (not shown in FIG. 3, see FIG. 1) with O₂ separated by the O₂ separator 17 to reform tar and lower hydrocarbons in the gasification gas;

a spray tower 19 which removes dust and trace constituents from the gasification gas reformed by the reforming furnace 18;

a desulfurization tower 20 which desulfurizes the gasification gas made free from the dust and the trace constituents by the spray tower 19;

a fine remover 21 which removes trace constituents such as light tar from the gasification gas desulfurized by the desulfurization tower 20;

a CO₂ separator 22 which separates CO₂ from the gasification gas (H₂, CO and CO₂) made free from the trace constituents such as light tar by the fine remover 21; and

an FT synthesizer 23 which conducts a Fischer-Tropsch synthesis reaction to adjust an H₂/CO ratio of the gasification gas made free from CO₂ by the CO₂ separator 22 to approximately 2 to thereby produce H₂ and CO as liquid fuel,

the above-mentioned CO₂ gas separation/circulation means being provided by the CO₂ separator 22 arranged in front of the FT synthesizer 23.

The CO₂ gas separated by the CO₂ separator 22 as CO₂ gas separation/circulation means is introduced, as shown in FIG. 4, into the hopper 14 storing the solid fuel and serving as system for supplying the solid fuel to the gasification furnace 2.

Next, an operation of the embodiment will be described.

In a case of the first embodiment shown in FIG. 3, in the high-temperature reforming furnace 18, the gasification gas produced in the gasification furnace 2 and made free from the bed material by material separator (not shown in FIG. 3; see FIG. 1) is mixed with O₂ separated by the O₂ separator 17 to reform tar and lower hydrocarbons in the gasification gas. In the spray tower 19, dust and trace constituents are removed from the gasification gas reformed by the reforming furnace 18. In the desulfurization tower 20, desulfurized is the gasification gas made free from the dust and the trace constituents by the spray tower 19. In the fine remover 21, trace constituents such as light tar are removed from the gasification gas desulfurized by the desulfurization tower 20. In the CO₂ separator 22, CO₂ is separated from the gasification gas (H₂, CO and CO₂) made free from the trace constituents such as light tar by the fine remover 21. In the FT synthesizer 23, the Fischer-Tropsch synthesis reaction is conducted to adjust the H₂/CO ratio of the gasification gas made free from the CO₂ by the CO₂ separator 22 to approximately 2 to thereby produce H₂ and CO as liquid fuel. The CO₂ gas separated by the CO₂ separator 22 as CO₂ gas separation/circulation means is introduced, as shown in FIG. 4, into the hopper 14 storing the solid fuel.

This introduction of the CO₂ gas into the hopper 14 serves for drying of the solid fuel in the hopper 14 as well as pressure-feeding of the solid fuel with the CO₂ gas, enabling steady supply of the solid fuel.

Further, the CO₂ gas is supplied from the hopper 14 through the screw feeder 15 and the fuel supply pipe 16 to the gasification furnace 2 so that a type of gasification reaction

C+CO₂→2CO

is promoted, leading to improvement of gasification efficiency.

It may be possible to introduce N₂ gas, steam, etc. into the hopper 14 instead. Introduction of the N₂ gas into the hopper 14 would cause a drop in calorific value of the gasification gas produced since such inert gas is admixed in the gasification furnace 2; introduction of the steam into the hopper 14 would require extra steam and deteriorate the overall efficiency of the system correspondingly. By contrast, in the embodiment, the CO₂ finally separated from the product or combustible gas such as H₂ and CO is circulated and utilized, so that there is absolutely no fear of the drop in calorific value of the gasification gas as in the case where the N₂ gas is used or the deterioration of the overall efficiency of the system as in the case where the steam is used.

As above, the CO₂ gas finally separated from the product or combustible gas such as H₂ and CO can be effectively utilized for supply of the solid fuel to the gasification furnace 2, and consequently the solid fuel can be stably supplied to the gasification furnace.

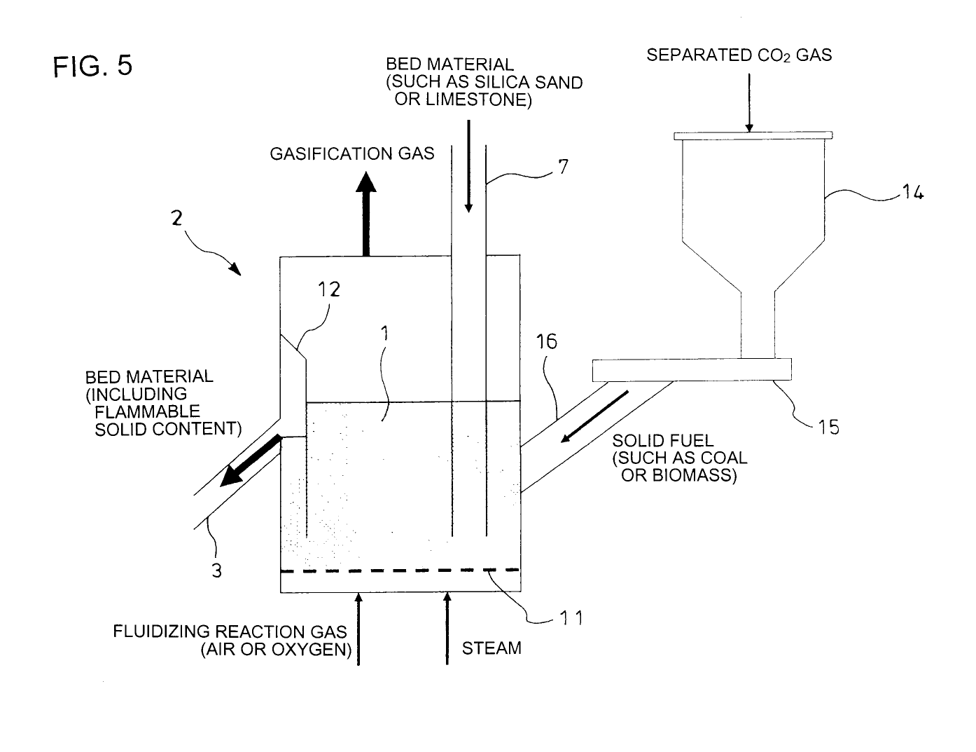

FIG. 5 is a relevant part diagram showing a modification of the gasification furnace 2 in which portions similar to those in FIGS. 3 and 4 are represented by the same reference numerals. The modification, which is similar in basic configuration to the embodiment shown in FIGS. 3 and 4, is characteristic as shown in FIG. 5 that the fuel supply pipe 16 is connected to the side surface of the gasification furnace 2 at a position lower than the top surface of the fluidized bed 1 so that the solid fuel is supplied from the fuel supply pipe 16 to an inside of the fluidized bed 1.

With this configuration in which the fuel supply pipe 16 is connected to the side surface of the gasification furnace 2 at a position lower then the top surface of the fluidized bed 1 to supply the solid fuel from the fuel supply pipe 16 to the inside of the fluidized bed 1, fine particles of the solid fuel are allowed to make full contact with the bed material without scattering unlike cases where the solid fuel is supplied from the fuel supply pipe 16 to the side surface of the gasification furnace 2 at a position above the fluidized bed 1 as in the example of FIG. 4, and the pyrolysis of the solid fuel is reliably completed to enhance achievable gas calorific value, i.e., cold gas efficiency as well as C- and H-conversion ratios while also enabling the reforming of tar in the gasification gas.

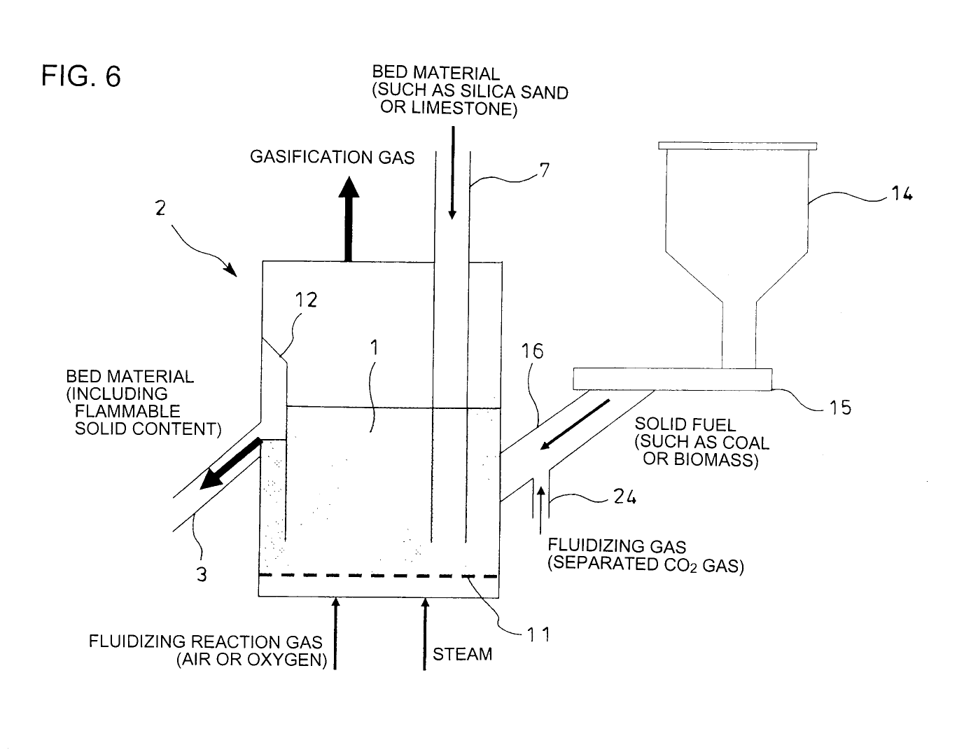

FIG. 6 is a relevant part diagram showing another specific example of the gasification furnace 2 in the first embodiment (see FIG. 3) of the invention in which portions similar to those in FIG. 3 or 5 are represented by the same reference numerals. The modification, which is similar in fundamental configuration to the fuel gasification equipment shown in FIG. 3 or 5, is characteristic in that, instead of introducing the CO₂ gas separated by the CO₂ separator 22 (see FIG. 3) as CO₂ gas separation/circulation means to the hopper 14 storing the solid fuel, a fluidizing gas pipe 24 is connected to the fuel supply pipe 16 serving as system for supplying the solid fuel to the gasification furnace 2, at a position close to the connection of the pipe 16 to the furnace 2 as shown in FIG. 6, and the CO₂ gas separated by the CO₂ separator 22 as CO₂ gas separation/circulation means is introduced into the fluidizing gas pipe 24 as fluidizing gas for stably supplying the solid fuel to the inside of the fluidized bed.

It may be conceivable that especially when biomass is used as the solid fuel in the configuration like FIG. 5 or 6 where the fuel supply pipe 16 is connected to the side surface of the gasification furnace 2 at a position lower than the top surface of the fluidized bed 1 so that the solid fuel is supplied from the fuel supply pipe 16 to the inside of the fluidized bed 1, the biomass, which contains more volatile components than coal and is easily gasificable, may heat up to some hundreds of degrees (° C.) to melt and gradually stick in the connection of the fuel supply pipe 16 to the gasification furnace 2, leading to clogging of the fuel supply pipe 16. In the example of FIG. 6, however, the CO₂ gas as fluidizing gas is supplied from the fluidizing gas pipe 24 connected to the fuel supply pipe 16 to promote the fluidity of the solid fuel; as a result, even when biomass is used as the solid fuel, sticking of molten biomass to the connection of the fuel supply pipe 16 is avoided and the fear of the clogging of the fuel supply pipe 16 is eliminated.

It goes without saying that, in the example of FIG. 6, alternatively the CO₂ gas separated by the CO₂ separator 22 (see FIG. 3) as CO₂ gas separation/circulation means may be introduced into the hopper 14 storing the solid fuel like the example of FIG. 5.

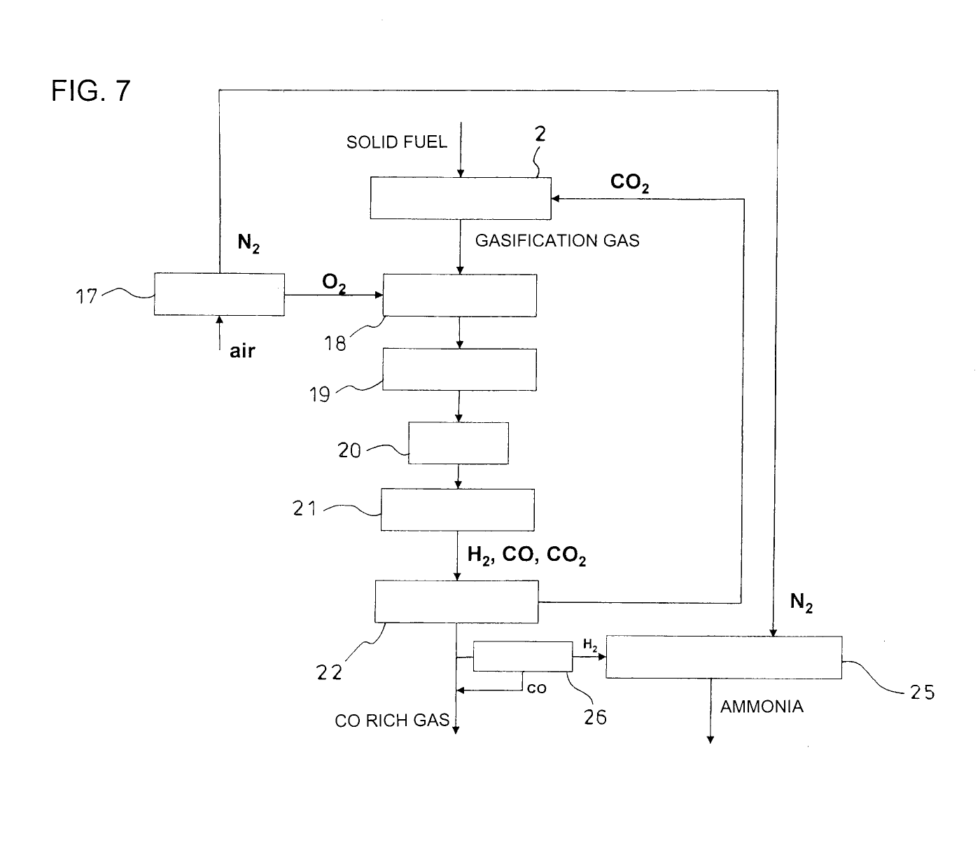

FIG. 7 shows a second embodiment of the invention in which portions similar to those in FIG. 3 are represented by the same reference numerals. This embodiment, which is similar in basic configuration to the embodiment shown in FIG. 3, is characteristic as shown in FIG. 7 that the CO₂ gas separation/circulation means is provided by a CO₂ separator 22 arranged in front of an ammonia synthesizer 25 which mixes N₂ with H₂ in the gasification gas to produce ammonia.

In this embodiment, an H₂ separator 26 is provided to separate H₂ from the gasification gas made free from CO₂ by the CO₂ separator 22. H₂ separated by the H₂ separator 26 is introduced into the ammonia synthesizer 25 for the ammonia-producing reaction. CO obtained by separation of H₂ by the H₂ separator 26 is returned to the gasification gas made free from CO₂ by the CO₂ separator 22.

Also in the system configuration shown in FIG. 7 employed, any of the types shown in FIGS. 4, 5 and 6 may be applied for a specific example of the gasification furnace 2 like the case of FIG. 3, and effects similar to those described above can be achieved.

It is to be understood that a fuel gasification equipment of the invention is not limited to the above-mentioned embodiments and that various changes and modifications may be made without departing from the scope of the invention.

1. A fuel gasification equipment characterized by comprising
a gasification furnace having a fluidized bed of a bed material formed with a fluidizing reactive gas for gasifying a solid fuel charged to produce a gasification gas and a flammable solid content; and
CO₂ gas separation/circulation means for separating CO₂ gas from the gasification gas produced in the gasification furnace and introducing the separated CO₂ gas to a supply system supplying the solid fuel to the gasification furnace.

2. A fuel gasification equipment as claimed in claim 1, wherein said CO₂ gas separation/circulation means is provided by a CO₂ separator arranged in front of an FT synthesizer for conducting a Fischer-Tropsch synthesis reaction to adjust an H₂/CO ratio in the gasification gas to approximately 2.

3. A fuel gasification equipment as claimed in claim 1, wherein said CO₂ gas separation/circulation means is provided by a CO₂ separator arranged in front of an ammonia synthesizer for producing ammonia through mixing of H₂ in the gasification gas with N₂.

4. A fuel gasification equipment as claimed in claim 1, wherein the CO₂ gas separated by said CO₂ gas separation/circulation means is introduced into a hopper storing the solid fuel.

5. A fuel gasification equipment as claimed in claim 2, wherein the CO₂ gas separated by said CO₂ gas separation/circulation means is introduced into a hopper storing the solid fuel.

6. A fuel gasification equipment as claimed in claim 3, wherein the CO₂ gas separated by said CO₂ gas separation/circulation means is introduced into a hopper storing the solid fuel.

7. A fuel gasification equipment as claimed in claim 1, wherein a fuel supply pipe is connected to a side surface of the gasification furnace at a position lower than a top surface of the fluidized bed to supply the solid fuel from the fuel supply pipe to an inside of the fluidized bed, a fluidizing gas pipe being connected to the fuel supply pipe close to a connection thereof to the gasification furnace for introduction of the CO₂ gas separated by the CO₂ gas separation/circulation means into the fluidizing gas pipe as fluidizing gas for stable supply of the solid fuel to an inside of the fluidized bed.

8. A fuel gasification equipment as claimed in claim 2, wherein a fuel supply pipe is connected to a side surface of the gasification furnace at a position lower than a top surface of the fluidized bed to supply the solid fuel from the fuel supply pipe to an inside of the fluidized bed, a fluidizing gas pipe being connected to the fuel supply pipe close to a connection thereof to the gasification furnace for introduction of the CO₂ gas separated by the CO₂ gas separation/circulation means into the fluidizing gas pipe as fluidizing gas for stable supply of the solid fuel to an inside of the fluidized bed.

9. A fuel gasification equipment as claimed in claim 3, wherein a fuel supply pipe is connected to a side surface of the gasification furnace at a position lower than a top surface of the fluidized bed to supply the solid fuel from the fuel supply pipe to an inside of the fluidized bed, a fluidizing gas pipe being connected to the fuel supply pipe close to a connection thereof to the gasification furnace for introduction of the CO₂ gas separated by the CO₂ gas separation/circulation means into the fluidizing gas pipe as fluidizing gas for stable supply of the solid fuel to an inside of the fluidized bed.

10. A fuel gasification equipment as claimed in claim 4, wherein a fuel supply pipe is connected to a side surface of the gasification furnace at a position lower than a top surface of the fluidized bed to supply the solid fuel from the fuel supply pipe to an inside of the fluidized bed, a fluidizing gas pipe being connected to the fuel supply pipe close to a connection thereof to the gasification furnace for introduction of the CO₂ gas separated by the CO₂ gas separation/circulation means into the fluidizing gas pipe as fluidizing gas for stable supply of the solid fuel to an inside of the fluidized bed.

11. A fuel gasification equipment as claimed in claim 5, wherein a fuel supply pipe is connected to a side surface of the gasification furnace at a position lower than a top surface of the fluidized bed to supply the solid fuel from the fuel supply pipe to an inside of the fluidized bed, a fluidizing gas pipe being connected to the fuel supply pipe close to a connection thereof to the gasification furnace for introduction of the CO₂ gas separated by the CO₂ gas separation/circulation means into the fluidizing gas pipe as fluidizing gas for stable supply of the solid fuel to an inside of the fluidized bed.

12. A fuel gasification equipment as claimed in claim 6, wherein a fuel supply pipe is connected to a side surface of the gasification furnace at a position lower than a top surface of the fluidized bed to supply the solid fuel from the fuel supply pipe to an inside of the fluidized bed, a fluidizing gas pipe being connected to the fuel supply pipe close to a connection thereof to the gasification furnace for introduction of the CO₂ gas separated by the CO₂ gas separation/circulation means into the fluidizing gas pipe as fluidizing gas for stable supply of the solid fuel to an inside of the fluidized bed.
